(19) United States
(12) Patent Application Publication
(10) Pub. No.: US 2002/0019755 A1
(43) Pub. Date: Feb. 14, 2002

(54) System and method for scheduling beauty salon appointments

(76) Inventor: Itsuo Kagami, Tokyo (JP)

Correspondence Address: FINNEGAN, HENDERSON, FARABOW,, GARRETT & DUNNER, L.L.P., 1300 I Street, N.W., Wahington, DC, 20005, US

(21) Appl. No.: 09/757,536

(22) Filed: Jan. 11, 2001

(30) Foreign Application Priority Data
Aug. 10, 2000 (JP) 2000-243110

(51) Int. Cl. G06F 17/60

(52) U.S. Cl. 705/5; 705/9

(57) ABSTRACT

The invention offers a system and method for scheduling appointments for beauty salons using communication environments such as the internet. The system also prevents false appointments which are foreseen as being a possible problem when enabling appointments with beauty salons to be made over such a communication environment. The system for scheduling appointments in beauty salons, comprises a memory device for storing a work schedules of a beauty salon; a data communication device for exchanging data with customers; and a central processing device for updating the work schedule based on appointment requests made by the customers; such that when a customer makes an appointment request, the appointment request is sent directly to the central processing device if the appointment request includes an identification number pre-assigned to the customer; and if the appointment request does not include an identification number, the customer is asked to input an address whereby the customer can be contacted by the data communication device, and the appointment request is sent to the central processing device only after the address is inputted; and appointment information prepared on the basis of the appointment request made by the customer is sent to the customer by the data communication device.

### BACKGROUND OF THE INVENTION

1. Field of the Invention

The present invention relates to a system for receiving requests for appointments at a beauty salon using communication means and automatically scheduling the work in the beauty salon. More specifically, the present invention relates to a beauty salon appointment scheduling system which handles appointments through the internet or the like by making appointments with respect to appointment requests with customer identification numbers, and with respect to appointment requests without customer identification numbers, determining whether information such as a mail address has been entered, and making appointments under the condition that such information has been entered, thereby preventing false appointments.

The present invention also relates to a beauty salon appointment scheduling method for the above-described system.

2. Description of Related Art

Appointments for beauty salons or the like are normally made by the customer over the telephone, and manually entered into a schedule at the beauty salon. When this method is used, customers who want to make an appointment must call the beauty salon, but are not able to do so when the beauty salon is closed, such as at night. Additionally, in order to respond to such telephone calls at the beauty salon, the stylists must interrupt their work, or else a receptionist must be hired to handle such calls.

On the other hand, communication means such as the internet are developing at a rapid pace, with an infrastructure enabling beauty salon appointments to be made over the internet already in place. However, since the contact between the customer and the beauty salon is much more tenuous when appointments are made over the internet as opposed to the telephone, cases in which customers do not actually appear at the time scheduled for the appointment may increase, thus presenting problems for the beauty salon.

### BRIEF SUMMARY OF THE INVENTION

In consideration of these problems, the present invention offers a system and method enabling beauty salon appointments to be made using communication means such as the internet. Additionally, the present invention offers a system and method for taking appointments which accepts only appointments for which the probability of the customer arriving at the appointed time is high, by preventing false appointments which are foreseen to be a potential problem when allowing beauty salon appointments to be made over such communication means.

According to a first aspect of the present invention, a system for scheduling appointments at beauty salons, comprises memory means for storing a work schedule of a beauty salon; data communication means for exchanging data with customers; and central processing means for updating the work schedule based on appointment requests made by the customers; such that when a customer makes an appointment request, the appointment request is sent directly to the central processing means if the appointment request includes an identification number pre-assigned to the customer; and if the appointment request does not include an identification number, the customer is asked to input an address whereby the customer can be contacted by the data communication means, and the appointment request is sent to the central processing means only after the address is inputted; and appointment information prepared on the basis of the appointment request made by the customer is sent to the customer by the data communication means.

According to a second aspect of the present invention, a method for scheduling appointments at beauty salons, comprising steps of receiving an appointment request for a beauty salon from a customer through data communication means; updating a work schedule of the beauty salon based on the appointment request from the customer; and sending the customer appointment information prepared on the basis of the customer's appointment request through the data communication means; wherein the appointment request is sent directly to the central processing means if the appointment request includes an identification number pre-assigned to the customer; and if the appointment request does not include an identification number, the customer is asked to input an address whereby the customer can be contacted by the data communication means, and the appointment request is sent to the central processing means only after the address is inputted.

Other features and effects of the present invention shall be made apparent in the following description which gives examples of non-limiting embodiments of the present invention.

### BRIEF DESCRIPTION OF THE DRAWINGS

FIG. 1 is a flow chart showing an example of the procedure whereby an appointment is registered based on an appointment request and the customer finally confirms the appointment, according to a first embodiment.

FIG. 2 is a flow chart showing an example of the procedure used when an appointment request without an identification number is received, according to the first embodiment.

FIG. 3 is a flow chart showing the procedure for appointment requests in which the stylist is not specified.

FIG. 4 is a flow chart showing the procedure for appointment requests in which the stylist is specified.

FIG. 5 is a flow chart showing an additional procedure which enables shopping to be performed.

FIG. 6 is a flow chart showing an additional procedure which enables information to be provided.

### DETAILED DESCRIPTION OF THE INVENTION

While the beauty salon appointment scheduling system according to a first embodiment of the present invention is contemplated for use with either data communication means such as the internet in conjunction with a computer capable of connecting to the data communication means and exchanging data, or with portable terminals or portable telephones having a data communication function, it is believed that portable terminals or portable telephones will be more commonly used by customers to transfer data. The memory means for storing the work schedule and central processing means can be such as are provided in personal computers. Such a personal computer could be used by a single beauty salon to handle its appointments, or may e shared by a plurality of beauty salons to handle their appointments integrally.

Here, customers making appointment requests without an identification number are asked to enter their addresses because appointments made through the internet, while offering the advantage of convenience, also have the drawback that unwanted appointments may increase, and this needs to be prevented. Since reception messages and acknowledgement mail is sent after the appointments have been made, only to customers with whom data has been exchanged over the internet, and this also aids in holding down false appointments.

Furthermore, the system may be such that upon receiving a customer address from a customer without an identification number, the customer is asked to confirm an appointment by return communication when sending the customer information about the appointment, and then retain the appointment if this appointment is confirmed within a predetermined period of time, but cancel the appointment if it is not confirmed within the predetermined period of time, thus allowing for a higher measure of security in making the appointment.

In a preferred modification of the present invention, the above-described system further comprises means for the beauty salon to change the set work schedule. This is to enable the system to take into account appointments made by telephone or orally during a visit, and to change the schedule accordingly. This could be accomplished by connecting to the system from the beauty salon, calling up a work schedule change screen and directly editing the schedule.

In another embodiment of the present invention, the memory means has a memory area corresponding to each of a plurality of beauty salons, stores the respective work schedules of the respective beauty salons in corresponding memory areas, and sends updated work schedules to the relevant beauty salons through the data communication means.

When an appointment request from a customer does not specify the beauty salon, information necessary to select a beauty salon is displayed to a customer who is prompted to make a selection. If the customer selects a beauty salon in response thereto, then the selection is followed, and if the customer does not select a beauty salon, then a beauty salon for making an appointment is selected in accordance with a set of rules that are preset for the system. The preset rules may be such as to select beauty salons near the customer's address or in the same region if the customer's address is known, beauty salons which have openings in their schedules, or on the contrary, beauty salons having a large number designated appointments.

In another embodiment of the present embodiment, the location of a beauty salon, map, transportation means, number of stylists, photo of the beauty salon, messages from the beauty salon and the like can be shown either alone or in various combinations as information given to make the selection of the beauty salon. First, a map can be displayed to have the customer designate the closest station, then the location of the beauty salons close to the chosen station can be displayed together with photos of the beauty salon or the like in such a way as to overlap the image of the map, thus enabling the customer to readily recognize the possible methods of transportation.

When an appointment request from a customer does not designate a stylist, a stylist with whom to make an appointment is selected according to a set of rules which are preset for the system. In this case, the preset rules may be such as to select stylists with openings in their schedules, or on the contrary, stylists who have been designated more often. Additionally, the level of freedom for accepting appointments later can be made higher by not displaying the name of the stylist when confirming the appointment, and only specifying the beauty salon and the date and time of the appointment. In order to do so, a flag to the effect that the selection of the stylist is provisional can be appended to appointments which do not designate a stylist, such that when the provisional selection conflicts with an appointment request which does designate the stylist made subsequently, the appointment with the stylist designated is given priority and the provisional selection is changed to another stylist without an appointment.

When an appointment request from a customer conflicts with an appointment which has already been set, the customer is shown conditions such as stylists which are free, or other dates and times which are open and prompted to make a selection, but in this case, appointments which specify the stylist by identification number are interpreted to have a strong preference for the stylist, so that the information is shown in the order of the times and dates for which the designated stylist is free, followed by the times and dates for which appointments can be made with other stylists. Should the data communication means have the ability to do so, these may of course be displayed simultaneously.

If an appointment is not possible at the designated date and time at the designated beauty salon, a customer who initiated the appointment request by selecting a beauty salon is shown times and dates for which appointments can be made at the same beauty salon, whereas a customer who selected the beauty salon on the basis of information is offered another beauty salon which satisfies conditions similar to the conditions used to select the first beauty salon from among the beauty salons for which appointments can be made at the designated date and time.

Appointment requests may also be wait-listed, such that appointments are made upon cancellation in the order in which requests are entered in the waiting list. The waiting list should preferably be capable of being referenced by both the customers and the salons.

When the progress of work at a salon necessitates a change in the appointment schedule, the customer may be sent notifications of the approximate waiting time or requests to change the appointment time. Furthermore, it is also possible to have the beauty salon remind the customer when the date and time of the appointment are approaching, by using the data communication means to communicate with the customer. This is a concession made in order to shorten the waiting time of customers at the beauty salon and time wasted by the beauty salon as much as possible, in view of the fact that the overall productivity drops severely when there are cancellations, and that it is difficult to predict accurately how much time will be required for work at the beauty salon.

In the present invention, the memory means for storing the beauty salon work schedule may be any storage medium capable of being written into or read from by a computer, such as a magnetic disk, magnetic tape, MO disk, CD, DVD or floppy disk. The data communication means for exchanging data with a customer may be any device capable of data communications, and may, for example, be a computer connected to a network or a portable telephone or terminal. The central processing means may be any type of device capable of performing calculations, computations and information processing, such as the CPU's of personal computers, servers, mini-computers or mainframes, and may reside not only in a single computer, but in a plurality of computers connected over a network.

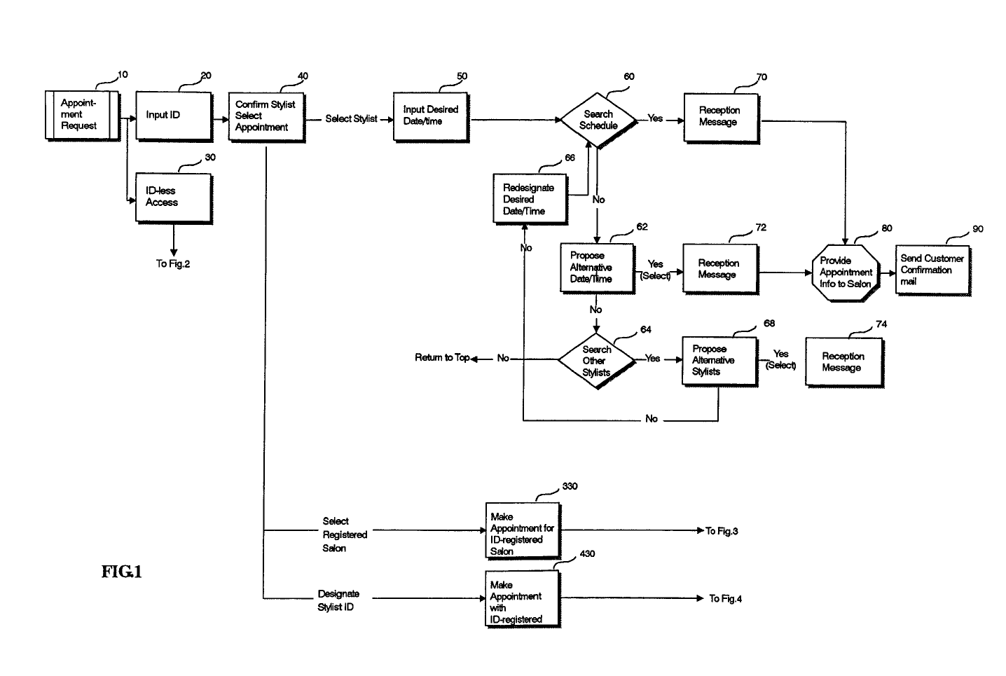

The basic procedure from when the appointment request is issued until the appointment is finalized in a beauty salon appointment scheduling system according to the present invention shall be explained with reference to FIG. 1.

First, an appointment request is sent 10 to the system through data communication means such as the internet. With respect to the appointment request, the system asks for the input of a customer identification number, and if an identification number has already been assigned to the customer, the customer inputs 20 the customer identification number, while on the other hand, if an identification number has not been assigned, the customer responds 30 by indicating that an identification number has not been assigned. As an alternative, the customer identification number may be sent simultaneously with the appointment request.

If the customer identification number is inputted 20, the system displays the name of a stylist who that customer has patronized before based on the customer identification number, and asks the customer to select whether he/she wishes to use the same stylist, the same beauty salon or to designate another stylist.

If a previously patronized stylist is selected, the customer is asked 50 to input a desired appointment date and time, which is then matched against the stylist's schedule to determine 60 whether or not an appointment can be fitted in. If the stylist is open on the desired appointment date and time, the appointment is made, and the system sends 70 the customer a reception message, as well as providing 80 appointment information describing that a new appointment has been established to the beauty salon. If the stylist's schedule is not open on the desired date and time, times and dates close to the date and time desired by the customer are displayed, and the customer is prompted 62 to select one if he/she desires to make an appointment for one of these times and dates. At the same time, the customer is shown 64, 68 a list of other stylists who are open at the designated date and time. If the customer is satisfied with one of the alternatives and chooses it, the appointment is made, the system sends 72, 74 the customer a reception message and the appointment information is provided 80 to the beauty salon.

In this example, a stylist must first be selected in order to make an appointment, but the system may be such that the customer selects only the beauty salon, leaving the selection of the stylist to the beauty salon. In this case, the date and time desired by the customer are given priority, with the system selecting a stylist from among stylists who are open at that time according to a predetermined procedure, and making the appointment. As the predetermined procedure, a method of making appointments in the order of stylists who were designated the most in a standard period of time, or a method of following an order predetermined by the beauty salon can be used. In this case, a flag indicating that the appointment is one that does not designate a stylist can be stored with the appointment data, so that if such an appointment conflicts with an appointment request designating that stylist, then the appointment with the flag can be moved to another stylist, thus increasing the freedom for receiving appointments.

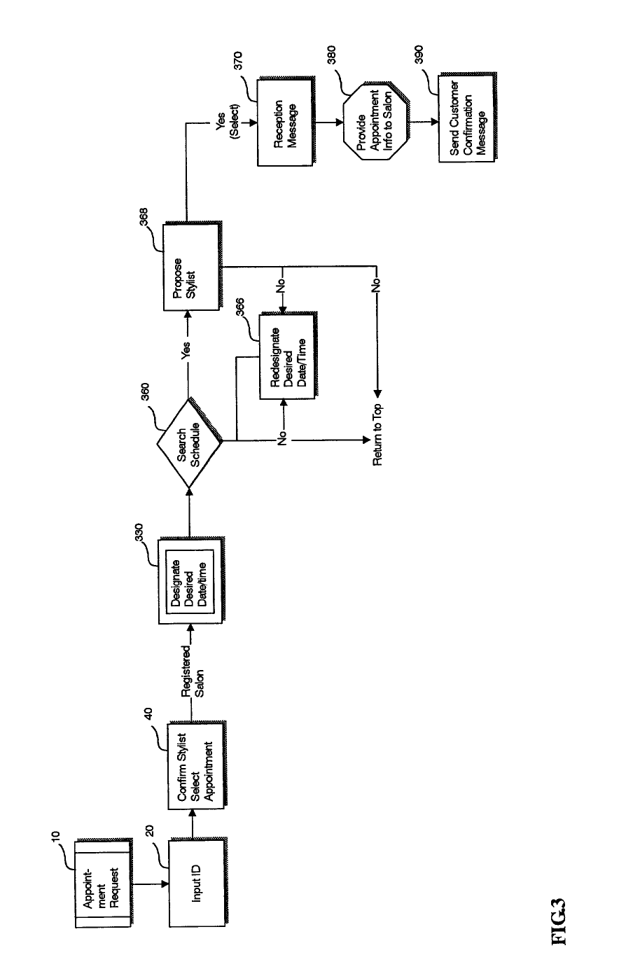

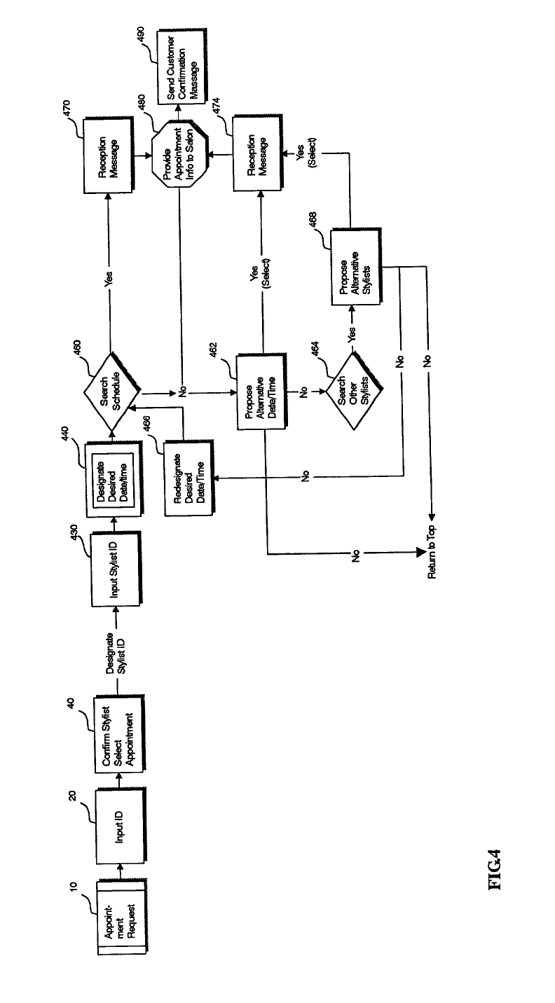

In the procedure whereby the customer makes a selection 40 of the beauty salon and a specific stylist, if the customer selects only the beauty salon and does not specify a stylist, the subsequent procedures are shown in FIG. 3, and the subsequent procedure when a specific stylist is designated by an identification number is shown in FIG. 4.

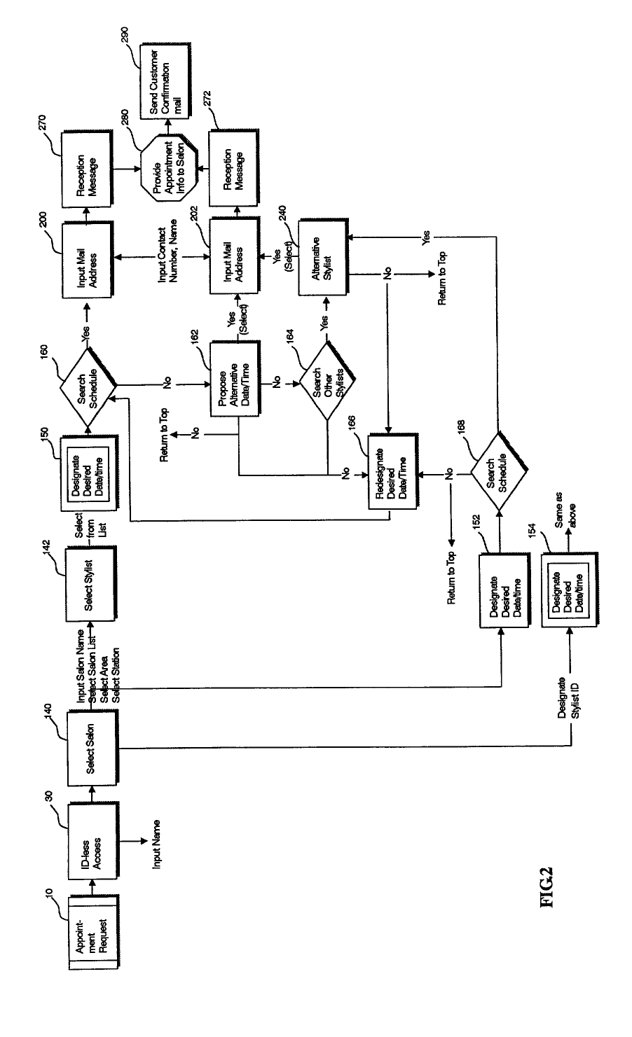

Next, the subsequent procedure for the case 30 when an appointment request does not include a customer identification number, that is, when a customer accesses the system for the first time shall be explained with reference to FIG. 2.

In the case 30 where an appointment request does not include the customer's identification number, the customer is shown 140 a beauty salon selection screen. Here, the stylists of the respective beauty salons are shown simultaneously with the salons, so that the appointment making process for a designated stylist can be initiated 154 by directly inputting the identification number of the stylist, thus skipping the step of selecting the beauty salon. The beauty salon selection screen includes not only a list of beauty salons, but also information necessary for selection a beauty salon according to the customer's preferences, e.g. beauty salons located in a specific geographical area, beauty salons located near a specified station, or newly opened beauty salons. Furthermore, more detailed information concerning specific beauty salons can be displayed on the screen in response to selection by the customer, such as the number of stylists, photos of the interior of the salon, or messages from the salon. When a customer selects a specific beauty salon based on this information, a list of stylists at the beauty salon is displayed.

Here, when the customer selects 142 a specific stylist displayed on the list, the system asks 150 for a desired date and time to be entered. If the desired date and time are acceptable, the appointment is made 270, but if there is a previously made appointment at that date and time, alternative dates and times, or stylists are displayed 162, 164, or the desired date and time are reset 166. The procedure used here is basically the same as that used in the above-described case where a customer identification number is entered.

However, in the flow chart shown in FIG. 2, when an acceptable stylist and time and date are decided, the system asks 200 the customer to enter an address by which the customer can be reached via data communications such as an email address or the like, and the appointment is established only after the customer has inputted an address, to which a reception message is then sent 270. Thereafter, the beauty salon is provided 280 with appointment information, and the customer is sent a confirmation message 290.

FIG. 3 is a flow chart showing the process followed when the customer first selects a beauty salon without specifying a stylist in the flow chart of FIG. 1. When the customer, having selected a beauty salon, enters 330 a desired appointment date and time, the system shows a list of stylists at the selected beauty salon who are open at the inputted date and time, and prompts 368 the customer to make a selection. When the customer selects a stylist from the list, the system returns 370 a reception message, provides 380 appointment information to the salon and sends 190 the customer a confirmation message.

Here, when the list of stylists is displayed, the customer may also make an appointment by selecting that he/she does not wish to designate a stylist, in which case, the selection of the stylist is left to the system or the beauty salon.

FIG. 4 shows the procedure followed when the customer, having entered 20 a customer identification number, wishes to make an appointment with a specific stylist by directly inputting the identification number of the stylist. In this case, if the designated stylist is open on the desired date and time and can receive the customer, there is no problem, but if there is a previously made appointment, then dates and times close to the preference are proposed 462, and other stylists are displayed 464 only when none of these dates and times are acceptable to the customer. This procedure gives priority to the designated stylist, under the assumption that a customer has a favorite stylist.

It is of course possible to display simultaneously dates and times on which the designated stylist is free and a list of stylists open at the designated date and time, or to list the appointment schedules of all stylists on and around the designated date and time.

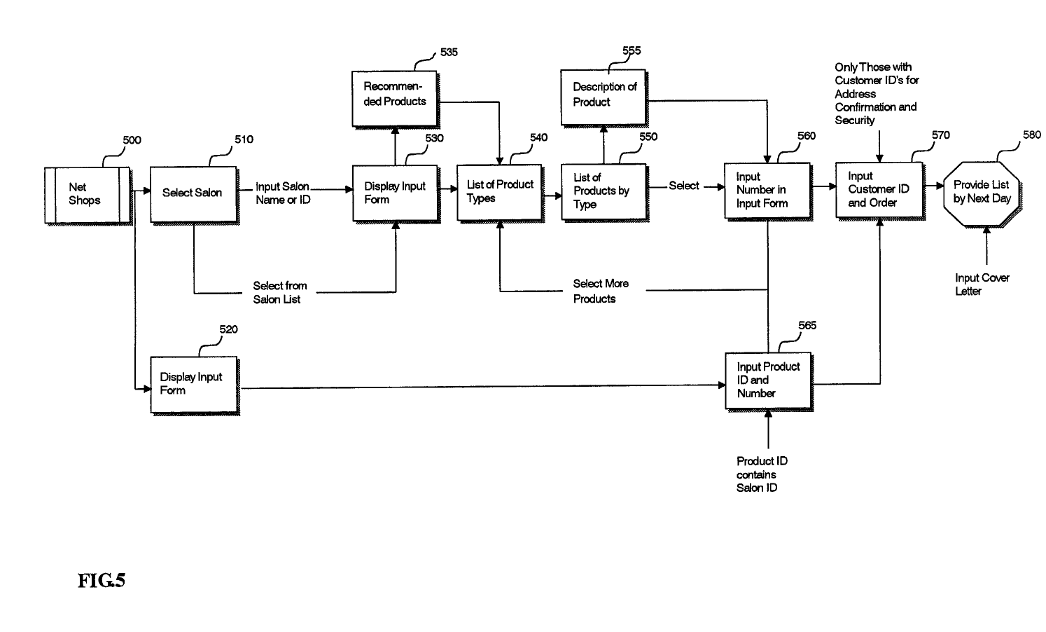

FIG. 5 is a flow chart showing the procedure used when a shopping service is offered for the customers using the above-described system.

When a shopping mall entrance 500 accessible via the internet is selected, the system displays 510 a beauty salon selection screen. When the customer selects the name or identification number of a salon, the screen jumps to pages divided by beauty salons, displaying a list 535 of recommended products or a list of product types 540. The customer, by passing through a list 550 of products divided by type and a page describing 555 a product, may then enter 560 a product number, number desired or the like in an order form and send the data to order a product which he/she wishes to purchase. In this case, it is possible to restrict 570 the orders so as to be capable of being made only by customers having a customer identification number for greater security. The customer may be sent back 580 a list of orders for confirmation.

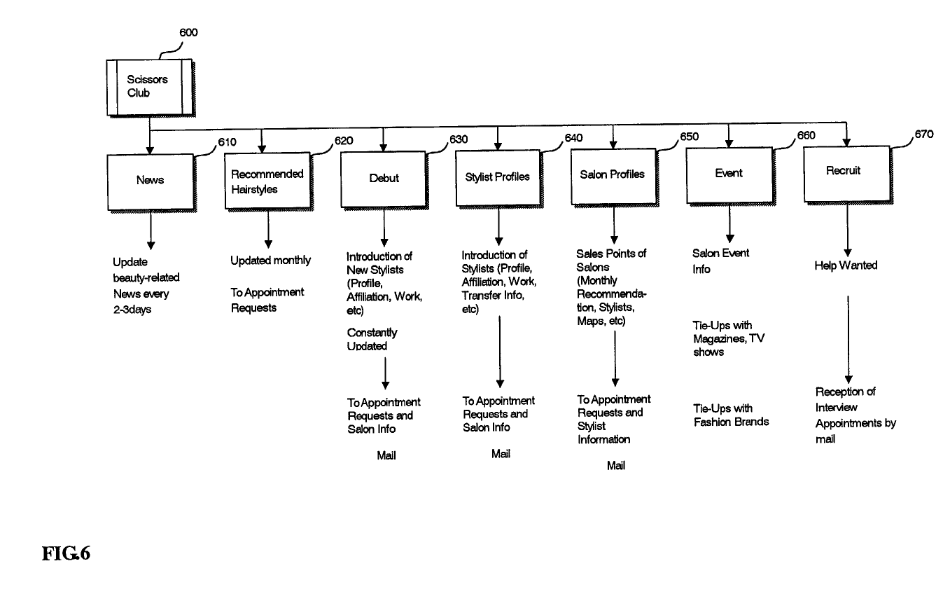

FIG. 6 shows a flow chart describing the procedure for providing various types of information to customers using the above-described system. Customers who have accessed an information page 600 accessible over the internet or the like can are shown news 610, hairstyles recommended by stylists 620, information concerning new stylists 660, personal information of stylists 640, information concerning beauty salons 650, information concerning various events sponsored by the beauty salons 660 and employment information 670. The specific content of these sites is as indicated in FIG. 6.

If the above-described central processing means includes additional memory means capable of storing appointment requests, it is possible to obtain statistical information which is useful for management of the beauty salons based on the stored past appointment request data, such as the relationships between number of appointments, day of the week, day of the month, time period, type of work performed, stylist, beauty salon and/or customer, which could render such information as what time periods are relatively less busy or which stylist does which type of work most often.

Additionally, since the central processing means is connected to many customers and beauty salons through the data communication means, it can be used to distribute email between customers and beauty salons, or to maintain an electronic bulletin board which is accessible by customers and beauty salons alike. The email can be such as to have the customer select the type of information which he/she wishes to receive, and to send email to each customer according to his/her preferences, thus allowing only email in which the customer has an interest to be sent. This type of information exchange may also be performed with respect ton only a specific group of customers or beauty salons. The central processing means has a memory area capable of being written into or read from by all beauty salons or beauty salons belonging to a specific group, the memory area being capable of being offered in the form of an electronic bulletin board.

It is also possible to include various advertisements in the electronic bulletin board, and in some cases, the email as well.

Furthermore, the beauty salon appointment scheduling system according to the present invention can be used to take and receive orders between beauty salons and their suppliers. In this case, the communications between the beauty salons and suppliers may be in the form of information exchange by email, but it is also possible to provide an electronic bulletin board giving a list of products which are available from a supplier, or an electronic bulletin board giving a list of products which a beauty salon is planning to purchase, with this information accessible by a plurality of beauty salons and/or suppliers.

Furthermore, while the present invention has been described as being applied to beauty salons in the present specification, the present invention shall not be construed as being restricted to only beauty salons, and can clearly be applied in similar fashion to barber shops, hospitals, dental clinics and massage parlors.

1. A system for scheduling appointments at beauty salons, comprising:
memory means for storing a work schedule of a beauty salon;
data communication means for exchanging data with customers; and
central processing means for updating said work schedule based on appointment requests made by said customers;
such that when a customer makes an appointment request, the appointment request is sent directly to said central processing means if said appointment request includes an identification number pre-assigned to said customer; and if said appointment request does not include an identification number, said customer is asked to input an address whereby said customer can be contacted by said data communication means, and said appointment request is sent to said central processing means only after said address is inputted; and
appointment information prepared on the basis of said appointment request made by said customer is sent to said customer by said data communication means.

2. A system for scheduling appointments at beauty salons in accordance with claim 1, further comprising means for the beauty salon to change the set work schedule.

3. A system for scheduling appointments at beauty salons in accordance with claim 1, wherein said memory means is capable of storing the work schedules of a plurality of beauty salons, and sending updated work schedules to respectively corresponding beauty salons through said data communication means.

4. A system for scheduling appointments at beauty salons in accordance with claim 1, wherein if the appointment request made by said customer does not specify a beauty salon, the customer is shown information to aid in selecting a beauty salon and prompted to make a selection, and if the customer selects a beauty salon, that selection is followed, whereas if the customer does not select a beauty salon, a beauty salon for making an appointment is selected by the system by following a preset set of rules.

5. A system for scheduling appointments at beauty salons in accordance with claim 4, wherein said information to aid in selecting a beauty salon includes one or more types of information chosen from among addresses of beauty salons, maps showing the locations of beauty salons, transportation means convenient to get to the beauty salons, number of stylists employed at the beauty salons, photos of the beauty salons and messages from the beauty salons.

6. A system for scheduling appointments at beauty salons in accordance with claim 1, wherein if the appointment request made by said customer does not specify a stylist, the system selects a stylist with whom to make an appointment according to a preset set of rules, then makes an appointment which includes a flag indicating that the selection is provisional, so that if an appointment request is subsequently made which designates that stylist and conflicts with said selection, then the appointment request which designates the stylist is given priority and the provisional selection is changed to another stylist who does not have an appointment.

7. A system for scheduling appointments at beauty salons in accordance with claim 1, wherein the central processing means which updates the work schedule based on appointment requests from customers, upon receiving an appointment request from a customer that conflicts with an appointment which has already been set, displays alternatives for which appointments can be made and prompts the customer to make a selection.

8. A system for scheduling appointments at beauty salons in accordance with claim 7, wherein said alternatives include one or more chosen from among other dates and times, other stylists and other beauty salons for which appointments can be made.

9. A system for scheduling appointments at beauty salons in accordance with claim 1, wherein appointment requests are wait-listed, and appointments made in the order of the waiting list when there are cancellations.

10. A system for scheduling appointments at beauty salons in accordance with claim 1, wherein if the scheduled appointments must be changed due to the progress of work at the beauty salon, the customer is sent a notification of the approximate waiting time or a request to change to appointment time.

11. A system for scheduling appointments at beauty salons in accordance with claim 1, wherein s aid central processing means includes additional memory means capable of storing appointment data, and said central processing means is capable of performing statistical analyses based on past appointment request data, concerning one or more chosen from among the relationships between number of appointments, day of the week, day of the month, time, type of work, stylist, beauty salon and customer.

12. A system for scheduling appointments at beauty salons in accordance with claim 1, wherein said central processing means has a memory area capable of being written into and read from by a plurality of beauty salons, said area being open as an electronic bulletin board or distributing email between said plurality of beauty salons.

13. A system for scheduling appointments at beauty salons in accordance with claim 1, wherein said communication means perform communications via the internet.

14. A method for scheduling appointments at beauty salons, comprising steps of:
receiving an appointment request for a beauty salon from a customer through data communication means;
updating a work schedule of said beauty salon based on the appointment request from the customer; and
sending the customer appointment information prepared on the basis of the customer's appointment request through said data communication means;
wherein the appointment request is sent directly to said central processing means if said appointment request includes an identification number pre-assigned to said customer; and if said appointment request does not include an identification number, said customer is asked to input an address whereby said customer can be contacted by said data communication means, and said appointment request is sent to said central processing means only after said address is inputted.
